(19) United States
(12) Patent Application Publication
(10) Pub. No.: US 2004/0193657 A1
(43) Pub. Date: Sep. 30, 2004

(54) Financial report distribution method and system

(75) Inventors: Nobuaki Saito, Yokohama (JP); Takeyoshi Yokosuka, Tokyo (JP); Seiji Futatsugi, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/741,295

(22) Filed: Dec. 19, 2003

(30) Foreign Application Priority Data
Mar. 19, 2003 (JP) 2003-074806

(51) Int. Cl. G06F 12/00

(52) U.S. Cl. 707/201

(57) ABSTRACT

In a financial report distribution system of the present invention, an event and schedule information database that stores event and schedule data indicating independently occurring changes in a market environment is provided in an analysis center. Independently occurring events in a stock market, such as stock transfer, merger, and acquisition are defined for each user. The financial report distribution system is equipped with an event-ready function: whenever such events have occurred, a merging DB in the system is updated, and a sequence of processes for the user from information processing through distribution of the processed information is automatically activated.

### BACKGROUND OF THE INVENTION

1. Field of the Invention

The present invention relates to a technology for processing predetermined information and distributing the processed information to an information receiving apparatus.

More specifically, the invention relates to a method and a system for processing financial information such as stock information in a market and the information on financial affairs into data table items that meet a request of the client and then distributing the processed financial information to a client's database. The financial information is distributed, based on a condition registered in advance, an environment, a format for the client, and the like.

2. Description of the Related Art

U.S. 2002/0065977A1 discloses the system in which information distributed from a provider is rated according to a personal profile learned in advance based on a preference of the client and then provided to the client.

With this system, market information data on stock prices and interest rates, and foreign exchanges and commodities, and financial information data are distributed from various information vendors and exchanges such as a stock exchange to users who utilize the data from investment advisors at timings defined in a predetermined data format.

After receiving these data, the user stores the data in databases of his company's server and his personal computer, updates the data in the databases, or utilizes information distributed in real time without alteration. Whenever performing an analysis, the user generates basic information as necessary, using the information he stores in his databases or provided in real time, creates analyzed information for supporting business by his own analysis tool, and makes use of the analyzed information for the business. However, under present circumstances, it takes much time and effort to perform this data processing. The user must receive information and generate the associated basic information as necessitated while always monitoring a market situation to see when the information he needs will occur.

The user performs such operations mainly because according to a request-reply system, he must frequently specify a form of distribution every time he has received raw data, or in some cases, the data in the information distributed in real time or at a timing defined by a distributor is not always the information needed by the user. Further, when an independently occurring change in the environment such as stock transfer due to a merger, which will be referred to below as an event has occurred, accurate information is not reflected, so that a risk resulting from a time lag is generated.

Still further, resources in the database that is not used might not be effectively utilized.

The user who has received distribution of information needs enormous time and effort in order to generate from the distributed information the basic information needed for his analysis, which is processing after the distribution of the information. Moreover, since freshness of information differs depending on the timing of the information distributed, the timing must be managed by the user every time the information has been distributed. Enormous effort by the user is therefore required.

### SUMMARY OF THE INVENTION

The present invention has been made to solve the above-mentioned problems. It is therefore an object of the invention to provide a method and a system for managing data processing information for generation of basic information by a user at a user site, and enabling distribution of the basic information capable of being analyzed by the user every time information is distributed. Another object of the invention is to provide the system that can automatically update the distributed information at a timing needed by the user, thereby providing a technology for minimizing an effort required to perform information analysis by the user of the distributed information. Still another object of the invention is to provide a method and a system for changing a request for processing financial information to accommodate an irregularly occurring event.

According to the present invention, there is provided

an analysis service system comprising:

a financial information database;

a database processor for updating the financial information database based on information received from an information vendor; and

a repository for storing a pair of a first data request received from a user site and timing data indicating when repetitive data should be acquired from the financial information database in response to the first data request;

wherein the repository stores a second data request received from the user site indicating independent data should be acquired from the financial information database.

In the present invention, information is automatically processed and distributed according to a format required by the user or an information receiving apparatus, a schedule defined in advance, and an independently occurring event for which the information is to be acquired. As one of the information for distribution, there is provided the financial information, for example. The financial information includes all the information that can be used as market information on stock prices and interest rates, foreign exchanges and commodities, and quantitative and qualitative information on financial affairs and earnings of public limited companies and listed companies.

More specifically, in order to solve the problems described above, a database for registering schedules is first provided for the system according to the present invention. Then, repetitive market information is defined and registered in advance, and a schedule table is referred to in real time or regularly. Generation and distribution of information is thereby automatically enabled at a timing needed by the user. Secondly, an information database for registering events or independently occurring changes in a market environment is provided, likewise. Then, independently occurring events in a stock market such as stock transfer, merger, and acquisition are defined for each user. With this arrangement, the system according to the present invention can be provided with a function to update a merging DB every time these events have occurred and automatically activate a sequence of processes from processing of the information for the user through distribution of the processed information. Thirdly, the format required by the user is stored. Distribution data can be extracted from a merging information database, can be processed in a form to comply with the required format, and can be distributed to a user's analysis system. With this arrangement, the user or analyzer can spend much time in performing the analysis alone. Fourthly, timings at which the user desires to acquire information are also registered in an event and schedule DB. The system according to the present invention can thereby automatically activate a sequence of program steps from generation and storage of information through processing and distribution of the information to the user, taking the event and schedule DB as an agent for the user.

As shown in an embodiment that will be described below, by referring to a time schedule of an event and schedule DB, the user can receive necessary information at a timing he needed. Further, the analysis center manages and uses the data format for the user as a repository. The user can thereby omit the time and effort for data processing.

Further, input of information required by the user can be performed to the user's analysis system timely and with a minimum time lag. Still further, by setting a condition needed for the analysis by the user in advance, processing and distribution of the information can be performed even if the user does not always monitor the market. Loss of time in various decision-making processes such as stock investment can be thereby prevented, and unnecessary risks such as an opportunity loss can be reduced.

### BRIEF DESCRIPTION OF THE DRAWINGS

FIG. 1 shows a configuration of a system according to the present invention;

FIG. 2 is a flowchart explaining acquirement of event information from a distributor according to an embodiment of the present invention;

FIG. 3 is a flowchart explaining generation of merged data;

FIG. 4 is a flowchart explaining processing for storing a data processing format according to the embodiment;

FIG. 5 is a flowchart explaining processing for data processing according to the embodiment of the present invention;

FIG. 6 shows a configuration example of an event definition DB;

FIG. 7 is a configuration example of an event and schedule DB;

FIG. 8 shows a configuration example of a stock price data DB;

FIG. 9 shows a configuration example of a financial data DB;

FIG. 10 shows a configuration example of a stock price index data DB;

FIG. 11 shows a configuration example of a foreign exchange data DB;

FIG. 12 shows a configuration example of a brand-by-brand merging DB;

FIG. 13 shows a configuration example of a time-by-time common information merging DB; and

FIG. 14 shows a configuration example of a repository.

### DETAILED DESCRIPTION OF THE EMBODIMENTS

Now, an embodiment of the present invention will be described in detail.

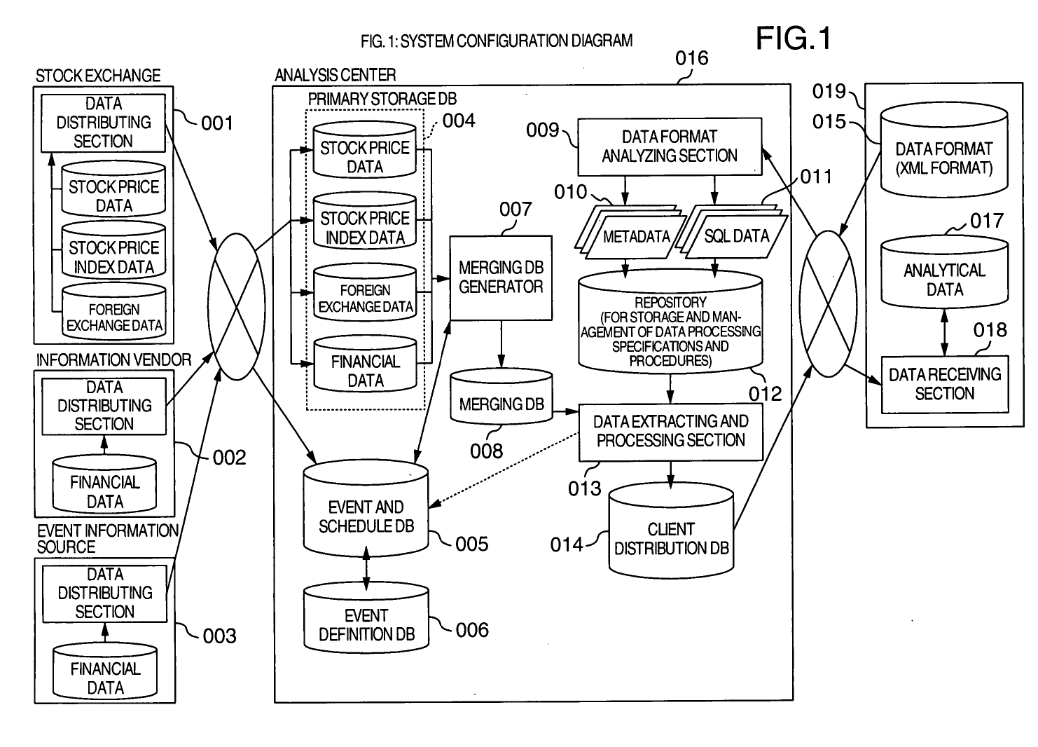

FIG. 1 is a block diagram showing a configuration of an analysis service system according to an embodiment of the present invention. The system is broadly divided into following three units:

(a) information sources or information vendors

(b) analysis center 016

(c) user site 019

The information vendors include a stock exchange 001 for distributing information such as stock prices and foreign exchanges, an information vendor 0002 for distributing financial data, and an event information source 0003 for distributing a daily event such as news information. Information is distributed from the information vendors 0001 to 0003 to the analysis center 016 based on a contract whenever necessary. The analysis center 016 temporarily stores the information received from the information vendors, performs necessary processing on the information, and distributes the processed information to the user site 019 as necessary.

The analysis center 016 includes a primary storage database (hereinafter referred to a DB) 004, an event definition DB 006, an event and schedule DB 005, and a merging DB 008. The primary storage DB 004 receives and stores stock price data, stock price index data, foreign exchange data, financial data, and event information in real time or regularly. The event definition DB 006 registers categories for independently occurring information (events). The event and schedule DB 005 stores schedule information, user's own definition information and pertinent brand information, or event occurring timings, for each user site. The schedule information includes the information on regularly and constantly occurring schedules such as time periods for a press release of earnings and brands associated with the press release and respective open and close times of trade markets. The user's own definition information includes information on release of specific statistical values (business and public statistics such as a production result) and the like. The merging DB 008 processes and merges primary data.

The analysis center 016 further includes a repository 012 and a client distribution DB 014. The repository 012 registers client needs concerning information distribution such as SQL (Structured Query Language) data 011 that defines a method of acquiring distributed information needed by a user, metadata 010 that defines the method of processing information. The client distribution DB 014 stores the information to be distributed to the user site. The analysis center 016 further includes a merging DB generator 007, a data format analyzing section 009, and a data extracting and processing section 013. The merging DB generator 007 is a program for processing and merging the primary data. The data format analyzing section 009 is the program for converting each data format 015 received from the user site 019 into a general-purpose format that can be managed by the analysis center 016 in a unified way. The data extracting and processing section 013 extracts from the merging DB 008 distributed data and processes the extracted data according to event and schedule information in the event and schedule DB 005 and information on the methods of acquiring and processing the information acquired from the repository 012.

The user site 019 includes a receiving server 018 for receiving distributed information from the analysis center 016 and analytical data 017 for storing the received information.

When information has satisfied a condition needed by the user based on this event and schedule information under management of the merging DB generator 007 and the data extracting and processing section 013, processes from generation to distribution of the information can be automatically activated. Accordingly, after having been processed based on the data format registered by the user in advance or whenever necessary, information can be distributed in a form that can be directly input to a use environment such as a client analysis.

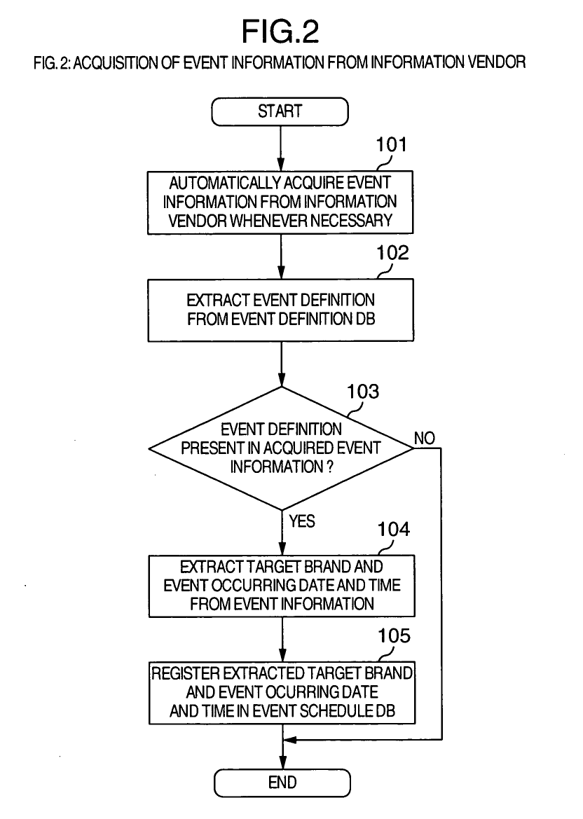

Now, with reference to FIGS. 2 to 13, an example will be described in which information has been acquired from the information vendor, and then based on the event and schedule information or information in the repository, information capable of being analyzed by the user is distributed in the system in this embodiment, configured as described above.

FIGS. 2 to 5 are flowcharts showing information processing procedures in this embodiment.

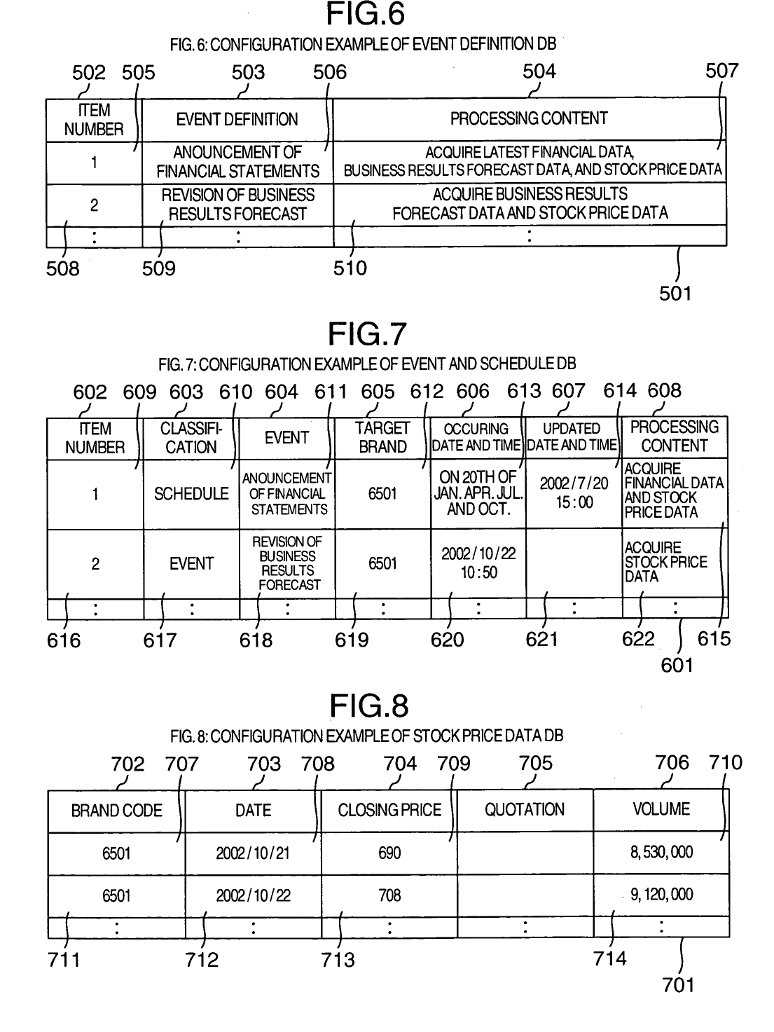

FIGS. 6 to 14 show examples of configuration of the databases used in this embodiment.

FIG. 2 is the flowchart showing processing from acquirement of information from the information vendor to storage in the event and schedule DB.

At step 101, the event information on news and market information as shown in FIGS. 7 to 10 is automatically obtained from the stock exchange 001, information vendor 002, and event information source 003 whenever necessary.

At step 102, event definitions, which are key words for defining the events are all extracted from event definition information as shown in FIG. 6 including the press release of earnings, revision of business results forecast, mergers and acquisitions that may affect financial affairs and stocks of companies.

At step 103, it is determined whether the event definitions acquired at step .102 are included in the event information obtained at step 101. If none of the event definition is included in the event information, the processing is terminated. If one of the event definitions is included in the event information, the operation transitions to step 104.

At step 104, information on a target stock and an event occurring date and time are extracted from the event information obtained at step 101.

At step 105, the event definition determined to be included in the event information at step 103, the information on the target stock and the event occurring date and time extracted at step 104, and a processing content are stored in the event and schedule DB as shown in FIG. 7. Together with the event information, the user can also register constantly occurring information as the schedule information, and performs updating the contents of the event and schedule DB.

FIG. 6 shows event definition data 501 stored in the event definition DB 006. The event definition data 501 indicates events and the processing contents associated with the events (information on source data to be acquired). The event definition data 501 is constituted from an item number 502, an event definition 503, and a processing content 504. A column for the item number 502 stores numbers representing an order of the data, as indicated by reference numerals 505 and 508. The column for the event definition 503 stores the contents of the event definitions as indicated by reference numerals 506 and 509. The column for the processing content 504 stores types of source data to be acquired for each event, as indicated by reference numerals 507 and 510.

FIG. 7 shows event and schedule data 601 stored in the event and schedule DB 005. The event and schedule data 601 indicates events and their classifications, information on the brands associated with the events, event occurring dates and times, and processing contents (information on source data to be acquired). The event and schedule data 601 is constituted from an item number 602, a classification 603, an event 604, a target brand 605, an occurring date and time 606, an updated date and time 607, and a processing content 608. The column for the updated date 607 stores a most recent date and time among the event occurring dates and times when the processing content was implemented. The column for the item number 602 stores numbers representing the order of the data, as indicated by reference numerals 609 and 616. The column for the classification 603 stores the classifications as represented by reference numerals 610 and 617, each indicating whether the event is a repetitive schedule or the event that can occur whenever necessary. The column for the event 604 stores the contents of the events as indicated by reference numerals 611 and 618. The column for the target brand 605 stores target brand information for the events or schedules, as indicated by reference numerals 612 and 619. The column for the occurring date and time 606 stores the dates and times as indicated by reference numerals 613 and 620, when the events or schedules will occur. The column for the updated date 607 stores the most recent dates and times that the processing content 608 was implemented according to the event and schedule DB, as indicated by reference numerals 614 and 621. The column for the processing content 608 stores data processing contents associated with the events, as indicated by reference numerals 615 and 622.

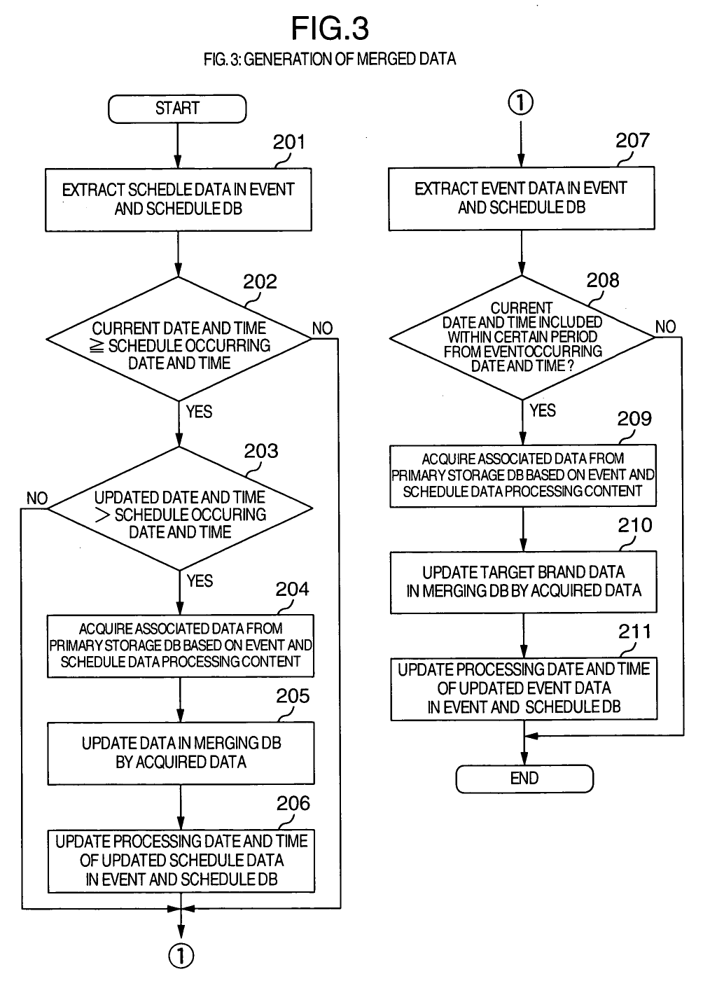

FIG. 3 is the flowchart showing the processing for generating merged data after information has been acquired from the information vendor.

At step 201, all the data with their classification 603 being the “schedule” are extracted from the event and schedule data 601 in the event and schedule DB 005 shown in FIG. 7 with a certain period regarded as an extraction cycle.

At step 202, respective event and schedule data occurring dates of the event and schedule data acquired at step 201 are compared with a current date and time. Only the event and schedule data with the occurring dates and times which are the same as and earlier than the current date and time are extracted, and the operation transitions to step 203. If there is no such data, the operation transitions to step 207.

At step 203, updated dates and times of the event and schedule data extracted at step 202 are compared with the occurring dates and times of the event and schedule data. Only the event and schedule data with their updated dates and times being later than their occurring dates are extracted, and the operation transitions to step 204. If there is no such data, the operation transitions to step 207.

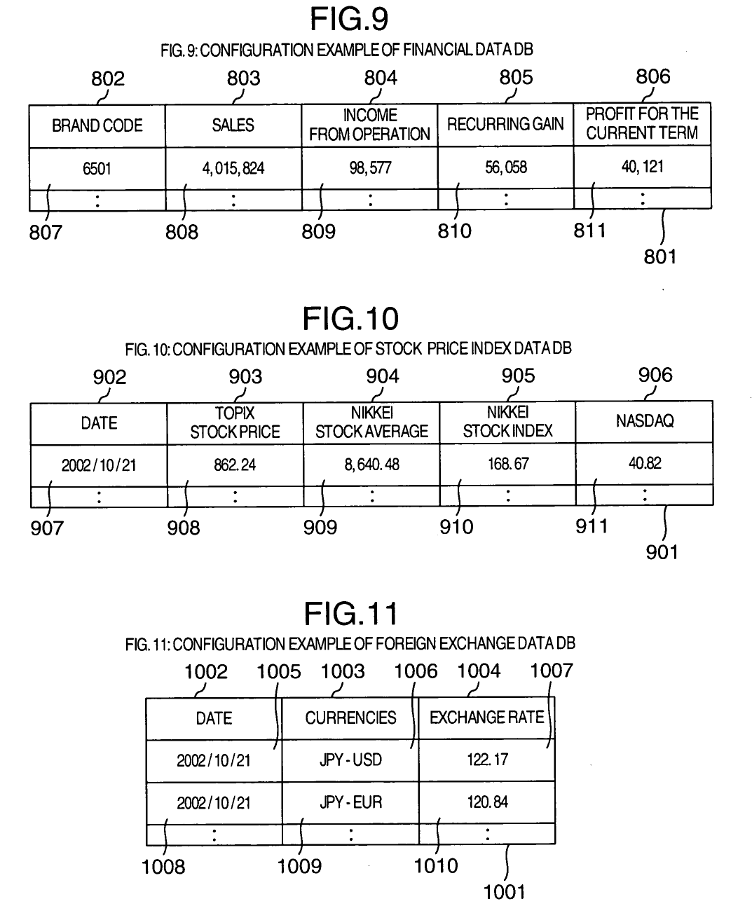

At step 204, information on all the event and schedule data extracted at step 203 is extracted from associated DBs in the primary storage DB according to the method of acquiring the data stored as the processing content. FIG. 8 shows stock price data 701 stored in the primary storage DB 004. The stock price data DB 701 indicates stock information and is constituted from a brand code 702, a date 703, a closing price 704, a quotation 705, and a volume 706 for each of the brands. The column for the brand code 702 stores brand codes as indicated by reference numerals 707 and 711. The column for the date 703 stores the dates as indicated by reference numerals 708 and 712, when information has been acquired. The column for the closing price 704 stores the closing prices as represented by reference numerals 709 and 713 indicating closing stock prices on associated dates, and the column for the volume 706 stores the volumes on the associated dates, as indicated by reference numerals 710 and 714. FIG. 9 shows financial data 801 in the primary storage DB 004. The financial data 801 indicates financial data for respective companies listed in the stock exchange, and is constituted from a brand code 802, sales 803, an income from operation 804, a recurring gain 805, and a profit for the current term 806. The column for the brand code 802 stores the brand codes of the companies listed in the stock exchange, as indicated by reference numeral 807. The column for the sales 803 stores the sales as indicated by reference numeral 808. The column for the income from operation 804 stores the income from operation, as indicated by reference numeral 809. The column for the recurring gain 805 stores the recurring gains, as indicated by reference numeral 810. The column for the profit for the current term 806 stores the most recent profit for the current term.

When the current date and time is 15:00 on Oct. 21, 2002 in the event and schedule data 601, for example, information on a brand “6501” in the target brand 619 and information on “acquisition of financial data and stock price data” in its processing content 622 are extracted and together with the current date Oct. 21, 2002 associated data are acquired. Based on the condition in the processing content, the brand code 707, date 708, closing price 709, volume 710 of the stock price data 701 are acquired, and the brand code 807, sales 808, income from operation 809, recurring gain 810, and profit for the current term 811 of the financial data 801 are acquired.

At step 205, the information in the primary storage DB 004 acquired at step 204 is stored in the merging DB 008.

FIG. 10 shows stock price index data 901 in the primary storage DB 004. The stock price index data 901 can include a date 902, a Tokyo stock price index (TOPIX) stock price 907, a Nikkei Stock Average 904, a Nikkei Stock Index 905, and a National Association of Securities Dealers Automated Quotations (NASDAQ) 906, and displays data associated with a plurality of specified dates.

FIG. 11 shows foreign exchange data 1001 in the primary storage DB 004 shown in FIG. 1. The dates and exchange rates between currencies requested by the client or user are displayed.

FIG. 13 shows a time-by-time common information merging DB in the merging DB 008 generated by the merging DB generator 007. The time-by-time common information merging DB includes a TOPIX stock price 1204, a Nikkei Stock Average 1205, a yen-to-dollar exchange rate 1206, a yen-to-euro exchange rate 1207, and an oil price 1208 on a time basis.

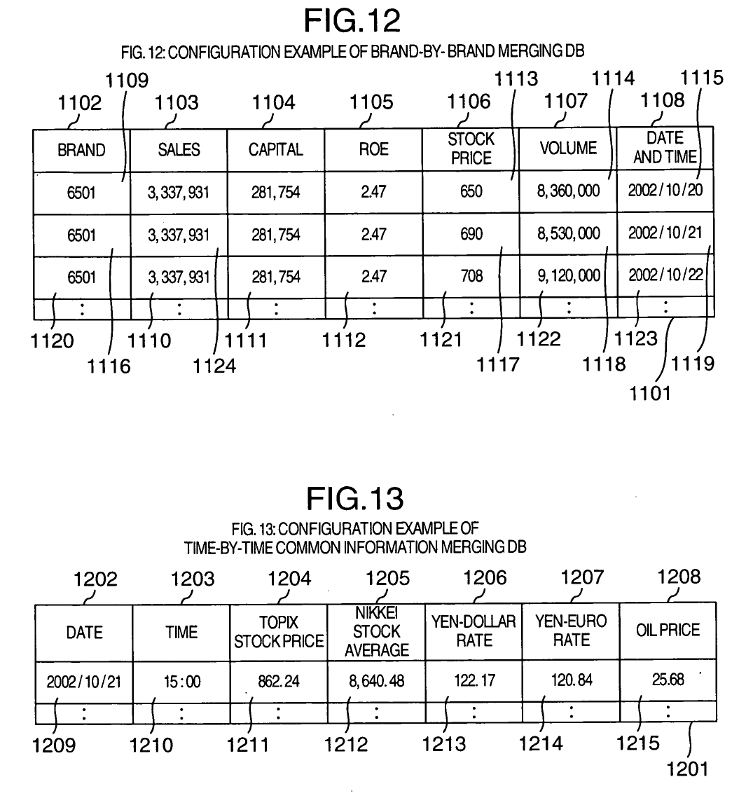

FIG. 12 shows brand-by-brand merged data 1101 stored in the merging DB 008. The brand-by-brand merged data 1101 indicates information that merges financial information and stock price information for each brand and is constituted from a brand 1102, sales 1103, a capital 1104, ROE 1105, a stock price 1106, a volume 1107, and a date and time 1108. The column for the brand 1102 stores brand codes as indicated by reference numerals 1109, 1116, and 1120. The column for the sales 1103 stores the sales as indicated by reference numerals 1110 and 1124. The column for the capital 1104 stores the capital for the brand, as indicated by reference numeral 1111. The column for the ROE 1105 stores the ROE (return on equity) as indicated by reference numeral 1112. The column for the stock price 1106 stores the stock prices on the dates, as indicated by reference numerals 1113, 1117, and 1121. The column for the volume 1107 stores the volumes for the brands, as indicated by reference numerals 1114, 1118, and 1122. The column for the date and time 1108 stores data reference dates as indicated by reference numerals 1115, 1119, and 1123.

For example, the brand code 707, date 708, closing price 709, volume 710 of the stock price data 701 acquired at step 204 are stored as the brand 1116, stock price 1117, volume 1118, and date and time 1119 in the brand-by-brand merging DB, and the brand code 807 and the volume 808 of the financial data 801 acquired at step 204 are stored as the sales 1124 in the brand-by-brand merging DB.

At step 206, when the information has been stored in the merging DB at step 205, the current date and time is stored in the updated date and time 607 in the event and schedule data 601 extracted at step 204. When the stock price data 701 and the financial data 801 have been updated at step 205, for example, the current date and time of 15:00 on Oct. 12, 2002 is stored in the current date and time 614 in the event and schedule data 601.

At step 207, all the data with their classification 603 being the “event” are acquired from the event and schedule data 601 from the event and schedule DB 005 shown in FIG. 7, with a certain period regarded as the cycle.

At step 208, respective event and schedule data occurring dates and times of the event and schedule data acquired at step 207 are compared with the current date and time. When the current date and time is within the certain period from the occurring dates and times of the event and schedule data, such event and schedule data are extracted, and the operation transitions to step 209. If there is no such data, the processing is terminated.

At step 209, information on all the event and schedule data extracted at step 208 is extracted from associated DBs in the primary storage DB according to the method of acquiring data stored as the processing content. When the current date and time is 15:00 on Oct. 22, 2002 in the event and schedule data 601, for example, information on the brand “6501” in the target brand 619 and information on “acquisition of stock price data” in its processing content 622 are extracted, and the associated data are acquired, together with the current date Oct. 22, 2002. Based on the condition in the processing content, the brand code 711, date 712, closing price 713, volume 714 are acquired from the stock price data 701.

At step 210, the information in the primary storage DB 0004 obtained at step 209 is stored in the merging DB 008. The brand code 711, date 712, closing price 713, and volume 714 of the stock price data 701 acquired at step 209 are stored as the brand 1116, stock price 1117, volume 1118, and date and time 1119 in the brand-by-brand merging DB.

At step 211, when the information has been stored in the merging DB at step 210, the current date and time is stored in the updated date and time 607 in the event and schedule data 601 extracted at step 209. When the stock price data 701 has been updated at step 210, for example, the current date and time of 15:00 on Oct. 22, 2002. is stored in the updated date and time 621 in the event and schedule data 601.

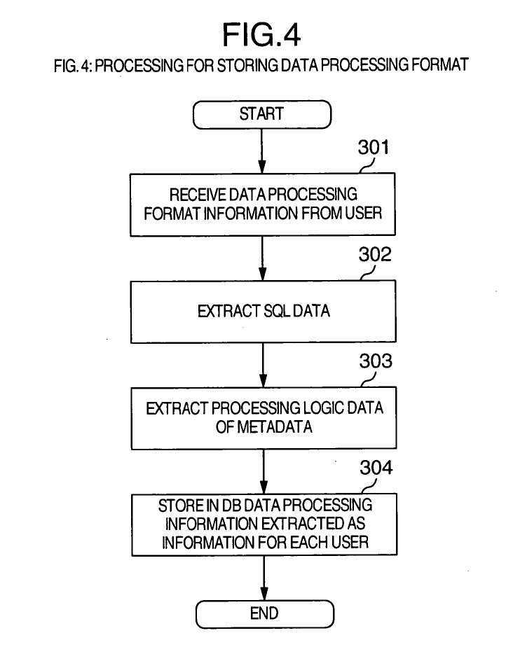

FIG. 4 is the flowchart explaining the processing of receiving a data processing format from the user, analyzing the data processing format, and storing the data processing format in the repository.

At step 301, the data processing format created at the user site 019 of the user who uses the analysis center 016 is converted according to the form of a certain data format, and then received at the analysis center 016.

At step 302, the method of acquiring data described using a certain grammar such as the SQL data and distribution data item definitions are extracted from the data processing format described in the form of the certain data format, received at step 301.

At step 303, from the data format described in the form of the certain data format received at step 301, a calculation formula or metadata for distribution data items calculated by operation on data items held in the merging DB is extracted as processing logic data.

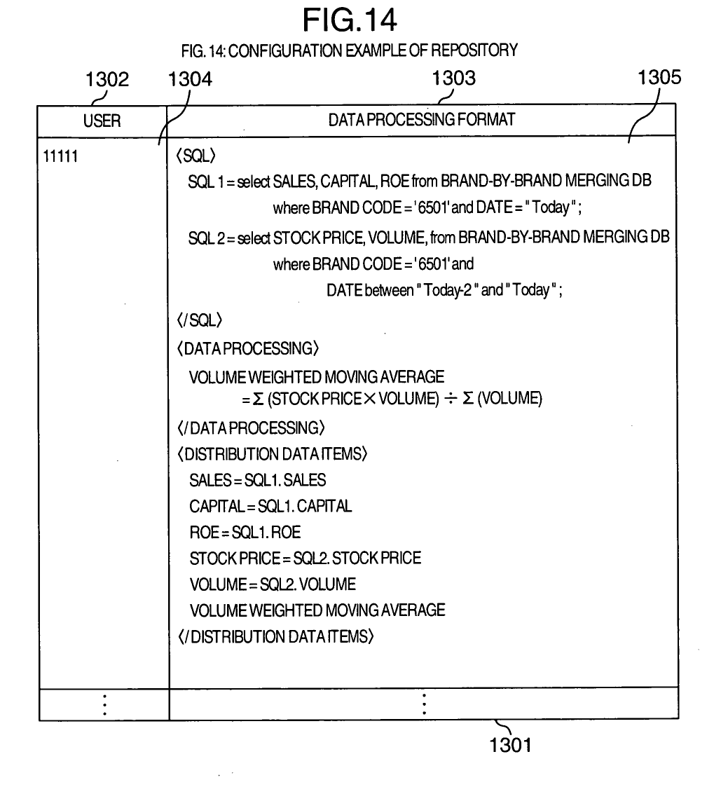

At step 304, the SQL data and the distribution data item definitions acquired at step 302 and the metadata acquired at step 303 are stored in the repository 012 as data processing information specific to the user. FIG. 14 shows repository data 1301 held in the repository 012. The repository data 1301 stores the data processing format such as a data processing format 1303 for each user such as a user 1302, according to the form of the certain data format (e.g. an XML format). The column for the user 1302 stores codes as indicated by reference numeral 1304, for identifying the users, while the column for the data processing format 1303 stores the method of acquiring data and the method of processing the data for automatically generating distribution data described in the form of the certain data format, as indicated by reference numeral 1305.

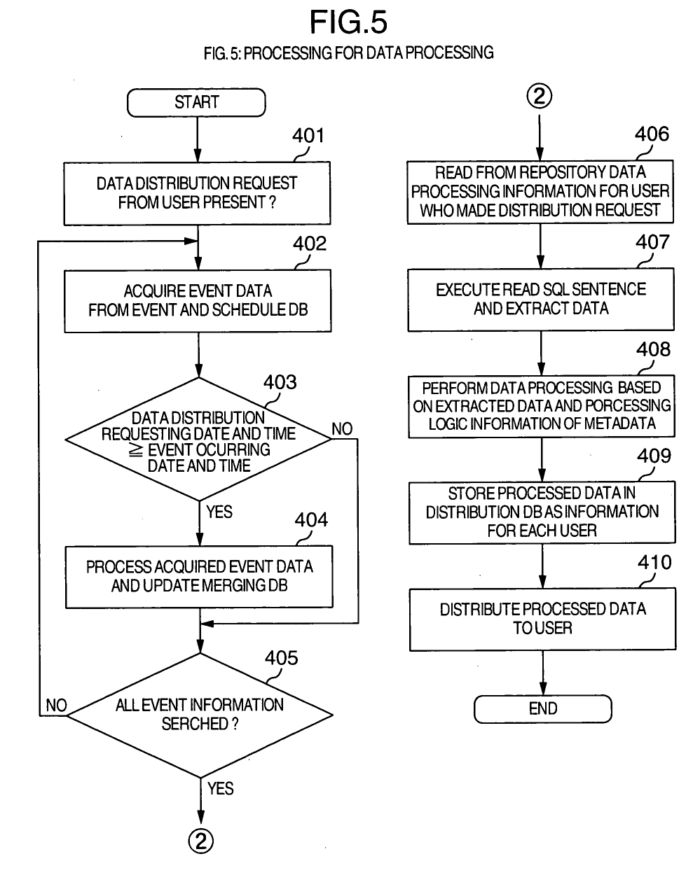

FIG. 5 is the flowchart showing the processing from reception of a distribution request for distribution of data from the user to distribution of processed data information.

At step 401, the request for distribution of the data is made to the analysis center 016 from the user site 019 of the user.

At step 402, the data extracting and processing section 013 of the analysis center.016 extracts from the event and schedule DB 005 one piece of data in the event schedule data 601, with its classification 603 being the “event” specific to the user site 019.

At step 403, the date and time when the request for distribution of the data has been made from the user site 019 at step 401 is compared with the event occurring date and time 606 of the one piece of data in the event and schedule data 601 extracted at step 402. When the date and time at which the data distribution request has been made is the same as or later than the event occurring date and time, the operation transitions to step 404. When the date and time at which the data distribution request has been made is earlier than the event occurring date and time, the operation transitions to step 405.

At step 404, information on the event and schedule data processed at step 403 is extracted from associated DBs in the primary storage DB according to the method of acquiring data stored as the processing content 608. When the date and time at which the data distribution request has been made is 15:00 on Oct. 22, 2002 in the event and schedule data 601, for example, information on the brand “6501” in the target brand 619 and information on “acquisition of stock price data” in its processing content 622 are extracted, and associated data are acquired, together with the current date Oct. 22, 2002 and the current time. Based on the condition in the processing content, the brand code 711, date 712, closing price 713, and volume 714 are acquired from the stock price data 701. Then, the information acquired from the primary storage DB 004 is stored in the merging DB 008. The brand code 711, date 712, closing price 713, and volume 714 of the stock price data 701 acquired, for example, are stored as the brand 1116, stock price 1117, volume 1118, and date and time 1119 in the brand-by-brand merging DB. Finally, the date and time at which the data distribution request has been made is stored in the updated date and time 607 of the event and schedule data 601.

At step 405, if all the data of the event and schedule data 601 specific to the user site 019 from which the data distribution request has been made, having their classifications being the “event” have been extracted at step 402, the operation transitions to step 406. If there is the data that is not processed, the operation transitions to step 402.

At step 406, the data processing format 1305 for the user site 019 from which the data distribution request has been made is extracted from the repository 012.

At step 407, a portion for data acquirement represented by sentences described in an SQL, for example, is extracted from the data processing format 1305 specific to the user site extracted at step 406, and necessary data are acquired from the merging DB 008. A following portion between <SQL> and </SQL> in the data processing format 1305, for example, is determined to be the method of acquiring data (described in SQL sentences, for example):

SQL1=select sales, capital, ROE from brand-by-brand merging DB

where brand code=‘6501’ and date=“Today”

SQL2=select closing price, volume from brand-by-brand merging DB

where brand code=‘6501’ and date between “Today-2” and “Today”

The above two SQL sentences are acquired and executed. When “Today” is set to Oct. 22, 2002 the sales 1110, capital 1104, ROE 1105 are acquired from the brand-by-brand merged data 1101 according to the SQL1. The stock prices 1113, 1117, and 1121 and the volumes 1114, 1118, and 1122 are obtained according to the SQL2.

At step 408, a portion for data processing such as the calculation formula is extracted from the data processing format 1305 specific to the user site extracted at step 406. After the extraction, using information acquired from the merging DB 008 at step 407, processed data is automatically generated. The following portion between <data processing item> and </data processing item> in the extracted data processing format 1305, for example, is determined to be the portion for data processing such as the calculation formula:

Volume Weighted Moving Average=Σ(stock price×volume)÷Σ(volume)

Then, the above calculation formula is obtained. When calculation is made using the stock prices 1113, 1117, 1121, and the volumes 1114, 1118, and 1122, acquired at step 407, the volume weighted moving average of 683.4548 is obtained.

At step 409, the data acquired or processed at steps 407 and 408 are stored in the client distribution DB 014 specific to the user site 019 from which the data distribution request has been made. Data items for the distribution are stored based on the form in the data processing format 1303. The sales 1110, capital 1111, ROE 1112, stock prices 1113, 1117, and 1121, volumes 1114, 1118, and 1122 for the brand “6501”, acquired at step 407 and the volume weighted moving average of “683.4548” calculated at step 408 are stored in the client distribution DB 014 specific to the user site 019. The portion between <distribution data items> and </distribution data items> is determined to be distribution data item definitions. Then, the sales 1110 is stored as the sales for distribution, the capital 1111 is stored as the capital for the distribution, the ROE 1112 is stored as the ROE for the distribution, the stock prices 1113, 1117, and 1121 are stored as the stock prices for the distribution, the volumes 1114, 1118, and 1122 are stored as the volumes for the distribution, the volume weighted moving average of “683.4548” is stored as the volume weighted moving average for the distribution.

At step 410, the distribution data automatically generated and stored in the client distribution DB at step 409 are transmitted to the user site 019 from which the distribution request has been made. After the transmission, the user site 019 receives the distributed data through the receiving server 018 and stores the distributed data as the analytical data 017 managed by the user site 019.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An analysis service system comprising:
a financial information database;
a database processor for updating the financial information database based on information received from an information vendor; and
a repository for storing a pair of a first data request received from a user site and timing data indicating when repetitive data should be acquired from the financial information database in response to the first data request;
wherein the repository stores a second data request received from the user site indicating independent data should be acquired from the financial information database.

2. The analysis service system according to claim 1,
wherein the repository stores a third data request indicating how the data in the financial information database should be processed; and
the analysis service system further comprises:
a distributing section for distributing to the user site the repetitive data and the independent data acquired according to the first and second requests and processed according to the third request.

3. The analysis service system according to claim 2, wherein the distributing section is connected to a plurality of user sites; and
the repository receives the first, second and third requests from each of the plurality of user sites and distributes the data according to the first, second, and third requests to said each of the plurality of user sites.

4. The analysis service system according to claim 1, wherein
the distributing section is connected to a plurality of user sites; and
the repository receives the first and second requests from each of the plurality of user sites and distributes the data according to the first and second requests to said each of the plurality of user sites.

5. The analysis service system according to claim 4, further comprising:
a merging database generator for merging the repetitive data and the independent data.

6. The analysis service system according to claim 5, wherein the independent data includes financial data resulting from stock transfer.

7. A financial data distribution program loaded into an analysis service system connected to an information vendor and a user site, comprising:
a program code for updating a financial information database based on information received from the information vendor;
a program code for storing a pair of a first data request received from the user site and timing data indicating when repetitive data should be acquired from the financial information database in response to the first data request; and
a program code for storing a second data request received from the user site indicating independent data should be acquired from the financial information database.

8. The financial data distribution program according to claim 7, further comprising:
a program code for storing a third data request indicating how the data in the updated financial information database should be processed; and
a program code for distributing to the user site the repetitive data and the independent data acquired according to the first and second requests and processed according to the third request.

9. The financial data distribution program according to claim 2, further comprising:
a program code for receiving the first, second and third requests from a plurality of user sites and distributing the data according to the first, second, and third requests to said each of the plurality of user sites.

10. The financial data distribution program according to claim 4, further comprising:
a program code for merging the repetitive data and the independent data.

11. An information distribution system for distributing financial information based on a plurality of financial data on finance to a plurality of information receiving apparatuses, the system comprising:
means for storing a request for each of the plurality of information receiving apparatuses;
means for merging the plurality of financial data into the financial information; and
means for converting the merged financial information to a plurality of processed information according to the stored request; wherein
each of the plurality of converted processed information is transmitted to an associated one of the information distribution apparatuses.

12. The information distribution system according to claim 11, wherein the merging means performs the merging when an event causing a change in the financial data has occurred.

13. The information distribution system according to claim 12, wherein the financial data includes at least one of stock price data indicating stock prices, foreign exchange data on foreign exchanges, financial data indicating financial affairs of companies, and stock price index data indicating financial indices.

14. The information distribution system according to claim 13, wherein the information distribution system is connected to a financial system for managing a financial market; and
the information distribution system further includes means for receiving the financial data from the financial system when the event has occurred in the financial market.

15. The information distribution system according to claim 14, wherein the financial market includes a stock market.

16. An information distribution method using an information distribution system for distributing financial information based on a plurality of financial data on finance to a plurality of information receiving apparatuses, wherein the method comprises the steps of:
storing a request for each of the plurality of information receiving apparatuses;
merging the plurality of financial data into the financial information;
converting the merged financial information to a plurality of processed information according to the stored request; and
transmitting each of the plurality of converted processed information to an associated one of the information receiving apparatuses.

17. The information distribution method according to claim 16, wherein the step of merging performs the merging when an event causing a change in the financial data has occurred.

18. The information distribution method according to claim 17, wherein the financial data includes at least one of stock price data indicating stock prices, foreign exchange data on foreign exchanges, financial data indicating financial affairs of companies, and stock price index data indicating financial indices.

19. The information distribution method according to claim 18, wherein the information distribution system is connected to a financial system for managing a financial market; and
the method further includes a step of receiving the financial data from the financial system when the event has occurred in the financial market.

20. The information distribution method according to claim 19, wherein the financial market includes a stock market.
